(19) United States
(12) Patent Application Publication
(10) Pub. No.: US 2026/0164320 A1
(43) Pub. Date: Jun. 11, 2026

(54) HANDOVER SUPPORT METHOD FOR IMPORTANT COMMUNICATION SERVICE, AND APPARATUS THEREFOR

(71) Applicant: HYUNDAI MOBIS CO., LTD., Seoul (KR)

(72) Inventor: SU HAN CHOI, Gwacheon-si, Gyeonggi-do (KR)

(73) Assignee: HYUNDAI MOBIS CO., LTD., Seoul (KR)

(21) Appl. No.: 19/127,362

(22) PCT Filed: Dec. 7, 2023
(86) PCT No.: PCT/IB2023/062342

§ 371 Date: May 5, 2025

(30) Foreign Application Priority Data
Nov. 29, 2022 (KR) 10-2022-0162313

(51) Int. Cl. H04W 36/00

(52) U.S. Cl. CPC H04W 36/0072; H04W 36/0077

(57) ABSTRACT

The present document relates to a handover support method for an important communication service, and an apparatus therefor. To this end, the method by which a user equipment (UE) performs handover in a mobile communication system comprises: receiving, through two or more bearers, a source network device and one communication service flow; additionally connecting to a target network device while maintaining connection to the source network device for a first bearer from among the two or more bearers; and disconnecting the two or more bearers from the source network device after completing a handover procedure with the target network device.

### TECHNICAL FIELD

The following description relates to a method for supporting handover of a user equipment (UE) in a system that stably provides an important communication service, and an apparatus therefor.

### BACKGROUND

Wireless communication systems use various technologies such as LTE, LTE-Advanced, and WiFi, including 5G. The three major requirement areas of 5G are (1) enhanced mobile broadband (eMBB), (2) massive machine type communication (mMTC), and (3) ultra-reliable and low latency communications (URLLC). Some use cases may require multiple areas for optimization, while other use cases may focus on only one key performance indicator (KPI). 5G supports these various use cases in a flexible and reliable manner.

Among them, URLLC includes new services that will change industries through ultra-reliable/available low-latency links, such as remote control of critical infrastructure and self-driving vehicles. The level of reliability and latency is essential for smart grid control, industrial automation, robotics, drone control, and coordination.

The URLLC technology described above may be seen as a way to provide an important communication service with ultra-reliability and low latency. Even in this case, however, a link may be disconnected due to a poor channel condition or for various reasons, and in particular, there are limitations in stably providing an important service in a high-speed, aerial situation such as an uncrewed aerial system (UAS) as well as general vehicle communication.

When a different bearer configuration is applied to stably provide the above-described important service, a handover method to support it is yet to be discussed.

### DISCLOSURE

### Technical Problem

In order to solve the above problem, one aspect of the present disclosure provides a method for stably providing an important communication service even in a situation such as a UAS, and an apparatus therefor.

Specifically, a method for configuring two or more bearers for one service flow to stably control a UAS and an important communication service as well as the UAS, a signaling method for efficiently performing handover in this case, and an apparatus therefor are provided.

Further, based on the assumption of various handover situations, a method for efficiently introducing the concept of dual active protocol stack (DAPS) handover to a duplexed/multiplexed bearer situation to provide a stable handover service, and an apparatus therefor are provided.

The problems which the present disclosure could solve are not limited to the problems described above, and other problems not described may be clearly understood by those skilled in the art to which the present disclosure belongs from the following description.

### Technical Solution

In an aspect of the present disclosure for solving the above problems, a method for supporting handover of a user equipment (UE) by a target network device to which the UE performs the handover in a mobile communication system is proposed, including receiving a handover request message for the UE by the target network device, wherein the handover request message includes bearer information configuring the UE to receive one communication service flow through two or more bearers from a source network device, and transmitting a handover request acknowledgment (Ack) message based on the bearer information by the target network device.

The handover request message may be received from the source network device, and the target network device may transmit the handover request Ack message to the source network device.

The handover request message may be received from an access and mobility management function (AMF), and the target network device may transmit the handover request Ack message to the AMF.

The handover request message may include a protocol data unit (PDU) session resource setup-related field including mapping information between a quality of service (QoS) flow and a data radio bearer (DRB), and the bearer information may be transmitted through the PDU session resource setup-related field.

The PDU session resource setup-related field may include an admitted QoS flow list and a non-admitted QoS flow list, and include information indicating a QoS flow to which two or more bearers are mapped, for at least one QoS flow identifier included in the admitted QoS flow list.

Among a first group for a guaranteed bit rate (GBR) resource type, a second group for a non-GBR resource type, a third group for a delay-critical GBR resource type, and a fourth group for a resource type of a QoS flow to which two or more DRBs are mapped, the at least one QoS flow identifier may be a QoS flow identifier corresponding to the fourth group.

Each of the source network device and the target network device may correspond to a gNB, wherein the mobile communication system may include the gNB and a core network (CN), and the two or more bearers may be established on a radio link between the UE and the gNB.

In this case, when the target network device performs a random access procedure with the UE and then receives a radio resource control (RRC) reconfiguration complete message from the UE, the handover of the UE may be processed as successful.

Each of the source network device and the target network device may correspond to a gNB, the mobile communication system may include the gNB and a CN, the two or more bearers may be established on a radio link between the UE and the gNB, and two or more service flows having the same QoS flow identifier (QFI) mapped to each of the two or more bearers may be created on a network link between the gNB and the CN.

When the target network device instructs the source network device to release a context of the UE, the handover of the UE may be processed as successful.

The target network device may perform handover for the two or more bearers simultaneously.

The target network device may start a service using the two or more bearers through one random access procedure from the UE.

The target network device may preferentially perform handover for one of the two or more bearers.

The two or more bearers may correspond to two or more data radio bearers (DRBs), respectively, the two or more DRBs may include a primary DRB and at least one secondary DRB, and the target network device may preferentially perform handover for the primary DRB among the two or more bearers.

After the handover for the primary DRB is completed, the target network device may operate to newly add the secondary DRB.

The target network device may preferentially perform handover for one of the two or more bearers in consideration of a received signal strength.

The mobile communication system may include an uncrewed aerial system (UAS), and the one communication service flow serviced through the two or more bearers may include a command and control (C2) communication service flow of the UAS.

The mobile communication system may include the UAS and a mobile communication service provider system, and the source network device and the target network device may link the mobile communication service provider system to the UAS.

The UE may include an uncrewed aerial vehicle (UAV).

In another aspect of the present disclosure for solving the above problems, a target network device to which a UE performs handover in a mobile communication system is proposed, including at least one processor, and at least one computer memory operably connectable to the at least one processor and storing instructions that, when executed, cause the at least one processor to perform operations. The operations include receiving a handover request message for the UE by the target network device, and transmitting a handover request Ack message based on the bearer information by the target network device, and the handover request message includes bearer information configuring the UE to receive one communication service flow through two or more bearers, when the UE configures a bearer with a source network device.

In another aspect of the present disclosure for solving the above problems, a method for performing handover by a UE in a mobile communication system is proposed, including receiving one communication service flow from a source network device through two or more bearers, additionally establishing a connection with a target network device while maintaining a connection to the source network device, for a first bearer among the two or more bearers, and disconnecting the two or more bearers from the source network device, after completing a handover procedure with the target network device.

The method may further including receiving a first message indicating addition of a bearer corresponding to a second bearer among the two or more bearers, after completing a radio link handover procedure for the first bearer with the target network device, and adding the bearer corresponding to the second bearer with the target network, in response to the first message.

The completion of the handover procedure may be determined on a condition that the bearer corresponding to the second bearer is added with the target network.

The completion of the radio link handover procedure for the first bearer may be determined on a condition that a random access procedure with the target network device is successful.

After the completion of the radio link handover procedure for the first bearer, the source network device may perform transfer of sequence number status information for data exchange between the target network device and the UE after the completion of the handover procedure, and the first message may be received after the transfer of the sequence number status information.

Each of the source network device and the target network device may correspond to a Node B (NB), the mobile communication system may include the NB and a CN, and the two or more bearers may be established on a radio link between the UE and the NB.

In this case, the first message may be received regardless of a path switching procedure of the target network device with the CN after the transfer of the sequence number status information.

Each of the source network device and the target network device may correspond to an NB, the mobile communication system may include the NB and a CN, the two or more bearers may be established on a radio link between the UE and the NB, and two or more service flows having the same QFI mapped to each of the two or more bearers may be created on a network link between the NB and the CN.

In this case, it is preferable to perform the path switching procedure of the target network device with the CN after the transfer of the sequence number status information by reflecting information of the first message.

The first bearer may be configured as a dual active protocol stack (DAPS) bearer.

The connection to the target network device for the first bearer may be additionally established based on receiving a handover command from the source network device, and the handover command may indicate DAPS handover in which the first bearer is specified as a DAPS bearer.

The handover command may be based on a handover request Ack message received by the source network device from the target network device, and the handover request Ack message may include information about the two or more bearers for the UE.

The two or more bearers may correspond to two or more DRBs, respectively and include a primary DRB and a secondary DRB, and the first bearer may correspond to the primary DRB.

In another aspect of the present disclosure for solving the above problems, a method for supporting handover of a UE by a target network device is proposed, including receiving a handover request message for the UE by the target network device, and transmitting a handover request acknowledgment (Ack) message in response to the handover request message by the target network device. At least one of the handover request message or the handover request Ack message includes information configuring a first bearer as a DAPS bearer among bearers configured for the UE to receive one communication service flow through two or more bearers from a source network device.

The handover request message may be received from the source network device, and the target network device may transmit the handover request Ack message to the source network device.

The handover request message may be received from an AMF, and the target network device may transmit the handover request Ack message to the AMF.

The method may further include, after completion of a radio link handover procedure for the first bearer with the UE, transmitting, a first message indicating addition of a bearer corresponding to a second bearer among the two or more bearers to the UE, and adding the bearer corresponding to the second bearer with the UE.

The completion of the handover procedure for the DAPS bearer may be determined on a condition that the bearer corresponding to the second bearer is added with the target network device.

In another aspect of the present disclosure for solving the above problems, a UE for performing handover in a mobile communication system is proposed, including at least one processor, and at least one computer memory storing instructions that, when executed, cause the at least one processor to perform operations. The operations include receiving one communication service flow from a source network device through two or more bearers, additionally establishing a connection with a target network device while maintaining a connection to the source network device, for a first bearer among the two or more bearers, and disconnecting the two or more bearers from the source network device, after completing a handover procedure with the target network device.

In another aspect of the present disclosure for solving the above problems, a target network device for supporting handover of a UE is proposed, including at least one processor, and at least one computer memory storing instructions that, when executed, cause the at least one processor to perform operations. The operations include receiving a handover request message for the UE by the target network device, and transmitting a handover request Ack message in response to the handover request message by the target network device. At least one of the handover request message or the handover request Ack message includes information configuring a first bearer as a DAPS bearer among bearers configured for the UE to receive one communication service flow through two or more bearers from a source network device.

### Advantageous Effects

According to the embodiments of the present disclosure as described above, an important communication service may be stably provided even in a situation such as a UAS.

Specifically, in a situation where two or more bearers are configured for one important communication service flow, efficient handover may be supported by efficiently transmitting messages between network entities to support handover.

In addition, based on the assumption of various handover situations, the concept of DAPS handover may be applied to provide a stable handover service, and a means may be provided to perform handover for a specific bearer corresponding to a DAPS bearer among duplexed/multiplexed bearers, and efficiently duplex/multiplex bearers in a target network.

The effects obtainable from the present disclosure are not limited to the effects described above, and other effects not described may be clearly understood by those skilled in the art to which the present disclosure belongs from the description below.

### BRIEF DESCRIPTION OF THE DRAWINGS

FIG. 1 is a diagram illustrating the concept of a UAS.

FIG. 2 is a diagram illustrating a method for receiving a communication service by a UE according to an embodiment of the present disclosure.

FIG. 3 is a diagram illustrating a method for supporting handover of a UE by a network according to an embodiment of the present disclosure.

FIG. 4 is a diagram illustrating a method for supporting handover of a UE by a network according to another embodiment of the present disclosure.

FIGS. 5 and 6 are illustrating the configuration of a handover request message and/or a handover request Ack message according to an embodiment of the present disclosure.

FIG. 7 is a diagram illustrating the concept of duplexing/multiplexing DRBs for an important communication service according to an embodiment of the present disclosure.

FIG. 8 is a diagram illustrating the concept of creating two or more service flows mapped to the same QFI on a network link for an important communication service according to an embodiment of the present disclosure.

FIG. 9 is a diagram illustrating a method for operating a service flow in each stage by a network according to an embodiment of the present disclosure.

FIG. 10 is a diagram illustrating changes of a QoS identifier used in a network according to an embodiment of the present disclosure.

FIGS. 11 and 12 are diagrams illustrating specific embodiments of the present disclosure in a 5G system.

FIG. 13 is a diagram illustrating a structure for duplexing/multiplexing DRBs for an important communication service according to an embodiment of the present disclosure.

FIG. 14 is a diagram illustrating various handover scenarios according to embodiments of the present disclosure.

FIG. 15 is a diagram illustrating the concept of DAPS handover to be applied in an embodiment of the present disclosure.

FIGS. 16 and 17 are diagrams illustrating a method for applying DAPS handover according to an embodiment of the present disclosure.

FIG. 18 is a conceptual diagram illustrating handover according to an embodiment of the present disclosure in comparison with general DAPS handover.

FIG. 19 illustrates wireless devices applicable to the present technology.

### DETAILED DESCRIPTION

With reference to the attached drawings, embodiments of the present disclosure will be described in detail so that those skilled in the art may easily implement the present disclosure. However, the present disclosure may be implemented in various different forms and is not limited to the embodiments described herein. In addition, in order to clearly describe the present disclosure, parts that are not related to the description are omitted in the drawings, and similar parts are given similar reference numerals throughout the specification.

Throughout the specification, when it is said that a part “includes” a certain component, this does not mean that other components are excluded, but that other components may be additionally included, unless otherwise specifically stated.

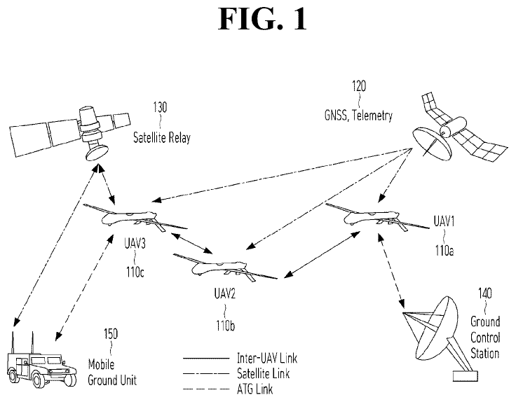

FIG. 1 is a diagram illustrating the concept of a UAS.

As illustrated in FIG. 1, the UAS may include one or more uncrewed aerial vehicles (UAVs) 110a, 110b, and 110c (e.g., drones) and at least one ground control station 140 (or a ground control center or a ground control server) that manages them, and may be linked to a mobile communication service provider system to provide an efficient communication service to the UAV(s).

In the following description, a ‘mobile communication system’ is assumed to be a concept including a mobile communication service provider system operated by a conventional mobile communication service provider, and a UAS. In such a mobile communication system, a conventional mobile communication service and a UAS service may be defined by a single communication standard (e.g., the 3GPP standard).

A network described below may operate to link the mobile communication service provider system to the UAS. That is, in the following description, the network is assumed to be a concept including a network of the mobile communication service provider system and a network for the UAS.

The UAVs 110a, 110b, and 110c may be used as a general concept for unmanned aerial logistics and/or transportation means capable of vertical takeoff and landing, which is only an embodiment. According to another embodiment of the present disclosure, the UAVs 110a, 110b, and 110c may be used as a concept that further includes manned aerial logistics and/or transportation means capable of vertical takeoff and landing.

The mobile communication system may be configured to include a network including a base station (BS) and a core network (CN), and various user devices liked to the network. Hereinafter, various user devices linked to the network will be collectively referred to as “user equipments (UEs)”, for the convenience of description.

In an embodiment, the network may be linked to the ground control station 140 and additionally linked to a global navigation satellite system (GNSS) 120 for providing location information and/or a satellite relay 130 for satellite communication.

In an embodiment, the UE may be provided with a global positioning system (GPS) receiver and directly receive a signal from the GNSS 120 and/or the satellite relay 130.

In another embodiment, the network may be used as a general concept including all of BSs, a CN, and the ground control station 140. In this case, the mobile communication system may be used as a concept including the UAS.

UEs receiving a communication service from the UAS may include not only the UAVs 110a, 110b, and 110c described above, but also a mobile ground unit 150. That is, the ‘UEs’ are assumed to be the UAVs 110a, 110b, and 110c for convenience in the following description, to which the UEs are not limited, and do not exclude the mobile ground unit 150 as illustrated in FIG. 1 or a general mobile phone/smartphone.

In FIG. 1, inter-UAV links may be established among the UAVs 110a, 110b, and 110c and correspond to sidelinks in the 3^{rd} Generation Partnership Project (3GPP). The UAVs 110a, 110b, and 110c may establish satellite links with the satellite units 120 and 130 and be connected to the ground units 140 and 150 via aerial to ground (ATG) links.

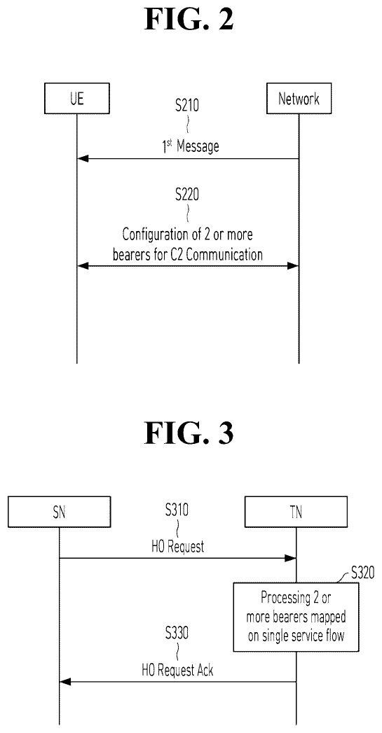

FIG. 2 is a diagram illustrating a method of receiving a communication service by a UE according to an embodiment of the present disclosure.

In 3GPP mobile communication to date, one bearer is configured and used for one specific service in a process of transmitting service data to one UE. In the present embodiment, however, the ground control station 140 of the UAS may provide a C2 communication service for monitoring the operation state of a UAV through a ground network or remotely controlling the UAV, and a method for configuring and using two or more bearers for one C2 communication service flow for an important communication service such as a C2 communication service by a network is proposed.

In the present embodiment, the importance of a communication service may be determined based on at least one of delay characteristics required for the service, security characteristics (or level) required for the service, whether it is related to the safety of operation (or driving), a data transmission error rate required for the service, or the reliability of link maintenance required for the service, to which the present disclosure is not limited, and the determination may be made by additionally considering various service characteristics according to the design of those skilled in the art.

Configuring a radio bearer (RB) means a process of defining the characteristics of radio protocol layers and channels and setting each specific parameter and operation method in order to provide a specific service. RBs may be divided into two types, signaling radio bearer (SRB) and data radio bearer (DRB). The SRB is used as a path for transmitting an RRC message in the control plane, and the DRB is used as a path for transmitting user data in the user plane.

To this end, it is proposed that in a mobile communication system including a UAS (or linked to the UAS via a network), two or more bearers such as DRBs are configured for a C2 communication service flow of a UAS, for example, for one service flow/bearer/session of the C2 communication service, when a UE receives a first message including bearer-related information, that is, information for bearer configuration or reconfiguration from a network (S210) and configures bearers with the network based on the first message (S220). Preferably, the bearer-related information included in the first message includes information configuring two or more bearers for one C2 communication service flow of the UAS.

The first message may be a radio resource control (RRC) reconfiguration message.

The description of FIG. 2 has been given on the assumption that the first message (S210) is an RRC message, to which the present disclosure is not limited, and the first message (S210) may be system information or a NAS message.

That is, in a PDU session setup or modification procedure, the UE may be provided with a QoS rule for mapping two or more DRBs to a QoS flow corresponding to a specific QFI through the NAS message (S210) received by the UE, and accordingly, the network may provide the C2 communication service through the two or more DRBs.

The RRC layer is defined only in the control plane. The RRC layer is responsible for controlling logical channels, transport channels, and physical channels in relation to the configuration, re-configuration, and release of RBs. An RB refers to a logical path provided by the first layer (physical layer or PHY layer), the second layer (medium access control (MAC) layer), the radio link control (RLC) layer, the packet data convergence protocol (PDCP) layer, and the service data adaptation protocol (SDAP) layer, for data transmission between the UE and the network.

When an RRC connection is established between the RRC layer of the UE and the RRC layer of a gNB, the UE is in the RRC_CONNECTED state, and otherwise, it is in the RRC IDLE state. In NR, the RRC_INACTIVE state is additionally defined, and a UE in the RRC INACTIVE state may maintain a connection, for example, a session with a CN, while releasing a connection, for example, a radio link from the gNB. This allows the UE to receive a fast communication service by establishing a radio link as needed without performing a separate session setup procedure in the RRC_INACTIVE state.

FIG. 3 is a diagram illustrating a method for supporting handover of a UE by a network according to an embodiment of the present disclosure.

In FIG. 3, ‘SN’ represents a source network device, and ‘TN’ represents a target network device. For example, in a 5G system, ‘SN’ may represent a source gNB, and ‘TN’ may represent a target gNB, to which the present disclosure is not limited, and devices corresponding to ‘SN’ and ‘TN’may be named in various ways according to standardization.

In FIG. 3, a TN may receive a handover request message from an SN (S310). The handover request message may be viewed as a message for notifying the TN that handover of a specific UE is required due to the reception signal quality of the SN and/or a measurement report of the UE. In the present embodiment, however, it is proposed to transmit such a handover request message including information indicating that the UE is configured to receive one communication service flow from the SN through two or more bearers.

For convenience of description, a communication service flow is interchangeably used with a ‘service flow’ in the following description.

Based on this bearer configuration information, the TN may perform processing for performing handover for two or more bearers mapped to one service flow (S320), and transmit a handover request acknowledgment (Ack) message to the SN based on the processing (S330).

When the TN/SN corresponds to a gNB, the method illustrated in FIG. 3 corresponds to an example of performing handover through an Xn interface in a 5G system. However, the 5G system also supports an access and mobility management function (AMF)-initiated handover in addition to the Xn interface-based handover.

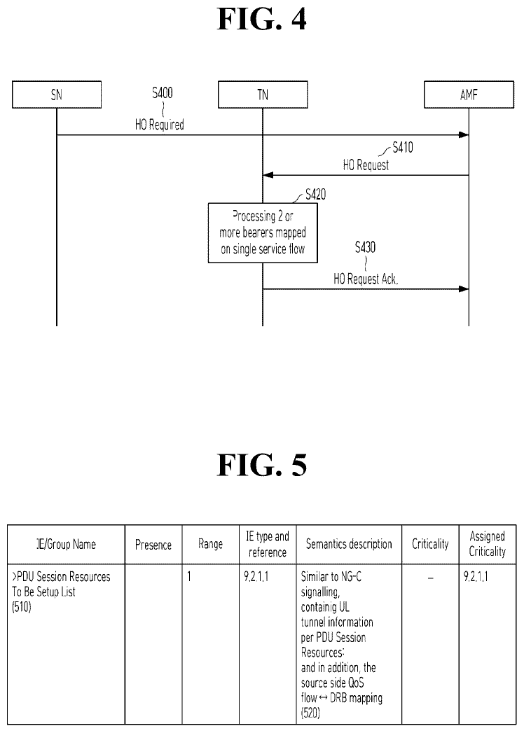

FIG. 4 is a diagram illustrating a method for supporting handover of a UE by a network according to another embodiment of the present disclosure.

FIG. 4 is an embodiment for describing a case in which a specific UE is registered not only in an SN/TN but also in an AMF at a CN end, and handover is initiated by the AMF.

According to an embodiment, the SN may determine whether handover is required based on a measurement report message including information about a received signal quality from a specific UE, and notify the AMF of the need for handover based on a result of the determination (S400). In this case, the AMF may transmit a handover request message to the TN (S410).

According to another embodiment, the SN may independently determine whether handover is required for the specific UE by considering at least one of an internal resource allocation state, an uplink channel state, a network load state, or an internal processing load state, and notify the AMF of the need for handover based on a result of the determination. In the present embodiment, it is proposed that the handover request message transmitted by the AMF includes information indicating that the UE is configured to receive one communication service flow through two or more bearers from the SN.

Based on this bearer configuration information, the TN may perform processing for performing handover for two or more bearers mapped to one service flow (S420), and transmit a handover request Ack message to the AMF based on the processing (S430).

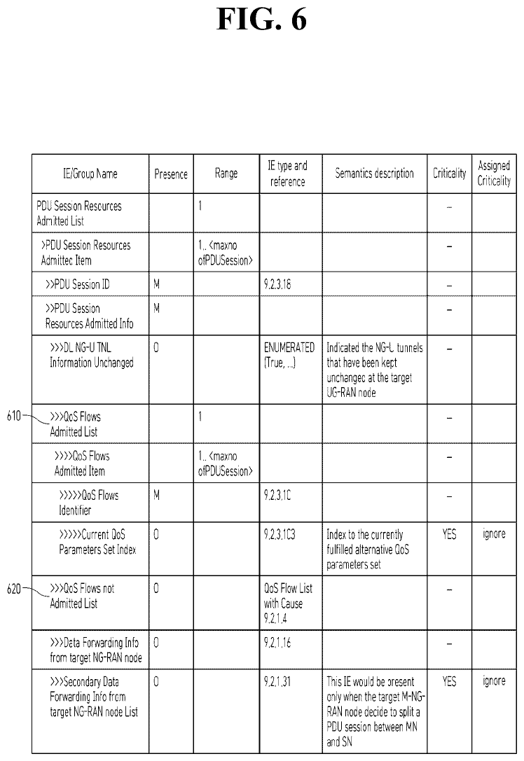

FIGS. 5 and 6 are diagrams illustrating the configuration of a handover request message and/or a handover request Ack message according to an embodiment of the present disclosure.

In the embodiments described in FIGS. 3 and 4, the handover request message and/or the handover request Ack message may include a protocol data unit (PDU) session resource setup-related field 510 including mapping information 520 between quality of service (QoS) flows and data radio bearers (DRBs), as illustrated in FIG. 5. In this message structure, the SN may include and transmit information indicating that two or more DRBs are mapped to one service flow in the mapping information 520 between the QoS flows and the DRBs, for an important communication service.

Further, in an embodiment of the present disclosure, the mapping information 520 or an additional field may include information that specifies a specific DRB as a DAPS DRB.

The PDU session resource setup-related field may include an admitted QoS flow list 610 and a non-admitted QoS flow list 620, as illustrated in FIG. 6. Among one or more QoS flow identifiers included in the admitted QoS flow list 610, the identifier of a QoS flow to which two or more bearers are mapped may be included, and preferably, information indicating this may be included.

The concept of bearer duplexing/multiplexing for an important communication service as described above will be described below in detail.

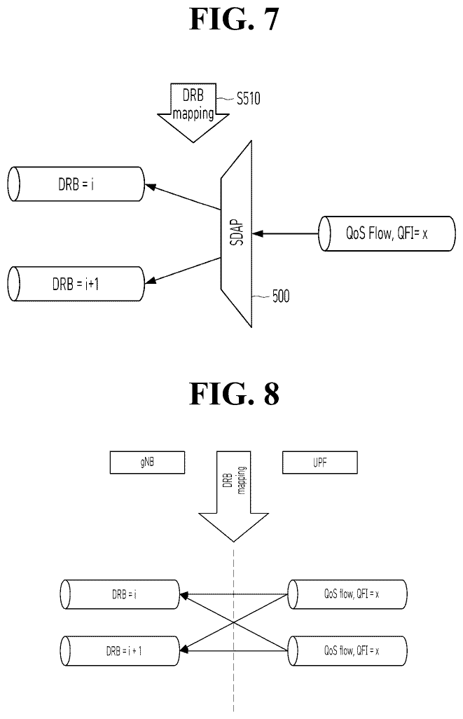

FIG. 7 is a diagram illustrating the concept of duplexing/multiplexing DRBs for an important communication service according to an embodiment of the present disclosure.

In FIG. 7, a transmitter that transmits data may be a UE for uplink transmission, a network for downlink transmission, and a gNB particularly on a radio link. A BS may be referred to as an eNB in LTE and a gNB in 5G, but it may be viewed as a general term for a node communicating with a UE through transmission on a radio link from the perspective of the network. For convenience of description, a BS is referred to as a gNB in the context of 5G, which should not be construed as limiting.

As illustrated in FIG. 7, a transmitting device may manage transmission data on a QoS flow basis, and for this purpose, assign an ID (QoS flow ID (QFI)) to each QoS flow. Accordingly, a specific entity (e.g., service data adaptation protocol (SDAP) 500) of the transmitting device may perform DRB mapping (S510) based on a QFI.

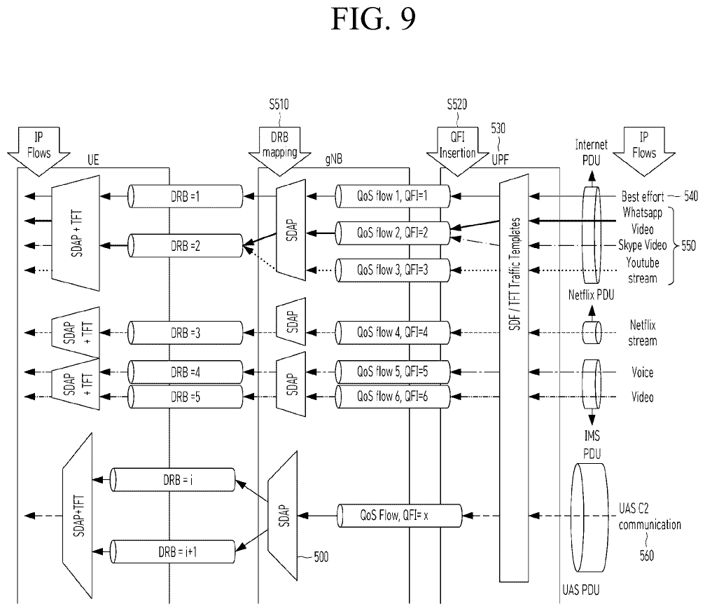

According to the current 5G standardization, there was no case of mapping a QoS flow corresponding to one QFI to two or more DRBs during the DRB mapping (S510) of the SDAP. As described later in relation to FIG. 9, the SDAP functions to map a QoS flow corresponding to one QFI to one DRB or multiplex two or more QoS flows to one DRB in the current 5G standardization.

However, in the present embodiment, a specific QFI (e.g., QFI=x) corresponding to an important communication service such as the C2 communication service of the UAS as described above may be defined, and it is proposed that for a QoS flow having the specific QFI, the corresponding service is provided by mapping the QoS flow to two or more DRBs, as illustrated in FIG. 7. The service with the specific QFI=x mapped to two or more DRBs or a QoS indicator group corresponding to a specific QFI group as described below does not need to be limited to the C2 communication of the UAS as described above. For example, in vehicle-to-everything (V2X) communication, a specific service requiring stability among services currently defined as ultra-reliable low-latency communication (URLLC) may be operated by mapping it to a QFI for which DRB duplexing/multiplexing is performed as described above.

FIG. 8 is a diagram illustrating the concept of creating two or more service flows mapped to the same QFI on a network link for an important communication service according to an embodiment of the present disclosure.

As described above with reference to FIG. 7, mapping two or more bearers to one QoS flow may be applied only to a radio link between a gNB and a UE. However, for an important communication service, paths also need to be duplexed/multiplexed on a network link in some cases, and FIG. 8 illustrates this concept.

In the embodiment illustrated in FIG. 8, it is assumed that two or more bearers are established on a radio link between a UE and a gNB. In addition, FIG. 8 illustrates the concept of creating two or more service flows having the same QFI (QFI=x) mapped to each of the two or more bearers on a network link between the gNB and a CN (specifically, a UPF).

FIG. 9 is a diagram illustrating a method for operating a service flow in each stage by a network according to an embodiment of the present disclosure.

As illustrated in FIG. 9, IP flows provided through a communication service may include a best effort service less sensitive to delay, such as a file download service, and a real-time video/audio streaming service sensitive to delay. In addition, the IP flows are shown as including an IP flow for UAS C2 communication in FIG. 8.

A CN that provides the communication service includes an entity of a session management function (SMF) (not shown), an entity of a user plane function (UPF) 530, and the afore-described AMF (not shown), and the various IP flows described above may form protocol data units (PDUs) for each service within the CN and provide them to the UPF 530.

The UPF 530 may perform data transmission through a traffic flow template (TFT) in consideration of a service data flow (SDF). Specifically, the UPF 530 may assign/map a QFI to an IP packet received for each SDF (S520).

The UPF 530 may map the IP packet received for each SDF to the corresponding QFI according to a packet detection rule (PDR) set by the SMF (not shown). In the present embodiment, an example is illustrated in which the UPF 530 maps an IP packet for a UAS C2 communication service flow to a specific QFI (=x) (S520).

Thereafter, a gNB of the network may perform DRB mapping corresponding to each QFI (S510), which may be performed by the SDAP 500 of the gNB, for example, for downlink transmission.

According to the current 5G standard as described above, when DRB mapping is performed on a QFI basis in the SDAP 500, only cases where a QoS flow corresponding to one QFI is mapped to one DRB (=1) such as a best effort service 540, or a QoS flow corresponding to a plurality of QFIs is mapped to one DRB (=2) such as various video services 550 have been specified.

However, the present embodiment proposes that for an important communication service such as a UAS C2 communication service 560, a service corresponding to one specific QFI is mapped to two or more DRBs (DRB=i and DRB=i+1) (S510). Preferably, an SDAP of a UE that receives data mapped to a plurality of DRBs in this manner extracts it as one QoS flow data, and it is proposed that decoding is performed efficiently by considering duplexing/multiplexing.

In the present embodiment, the importance of a communication service may be determined based on at least one of delay characteristics required for the service, a guaranteed bit rate (GBR) required for the service, security characteristics (or level) required for the service, whether it is related to the safety of operation (or driving), a data transmission error rate required for the service, or the reliability of link maintenance required for the service, to which the present disclosure is not limited, and the determination may be made by additionally considering various service characteristics according to the design of those skilled in the art.

Although the example of FIG. 9 has been described in the context of downlink data transmission, the concept of DRB duplexing/multiplexing described above may also be substantially applied in the same manner to uplink data transmission.

Specifically, in the case of uplink data transmission, the QFI mapping (S520) and the DRB mapping (S510) may be performed in the UE, and the UE may receive a QoS-related rule through a non-access-stratum (NAS) message received from the network. Specifically, in a PDU session setup or modification procedure, the UE may be provided with a QoS rule (or QoS policy) for mapping two or more DRBs to a QoS flow corresponding to a specific QFI.

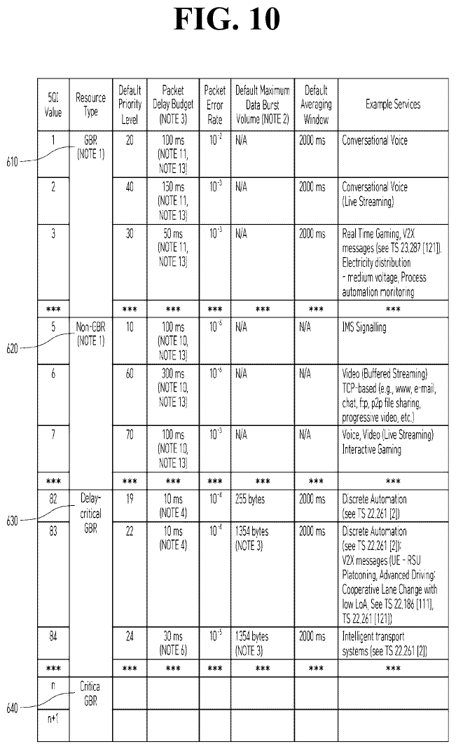

FIG. 10 is a diagram illustrating changes of a QoS ID used in a network according to an embodiment of the present disclosure.

The table illustrated in FIG. 10 is a diagram for describing the concept of groups which are added according to the present embodiment, based on the concept of a 5G QoS identifier (5QI). However, the term 5QI is a concept used in 5G standardization, and does not need to be construed as limiting. For example, when 5GIs are managed in groups for standardized management on a QoS flow basis in a 6G network, they may be referred to as 6QIs.

For current 5QIs, a first group 610 for a GBR resource type, a second group 620 for a non-GBR resource type, and a third group 630 for a delay-critical GBR resource type are defined, and QoS flows are managed/operated through the groups. However, the present embodiment proposes that a fourth group 640 for a resource type for a QoS flow to which two or more DRBs are mapped as described above is additionally included and operated.

Preferably, the fourth group 640 is set for a resource type for a QoS flow for which ultra-reliability or duplicity characteristics are considered additionally, compared to the third group 630.

Although the QoS ID groups as illustrated in FIG. 10 may be used by the UPF 530 of FIG. 8, they may also be used by various entities within an E2E link as well as the UPF 530.

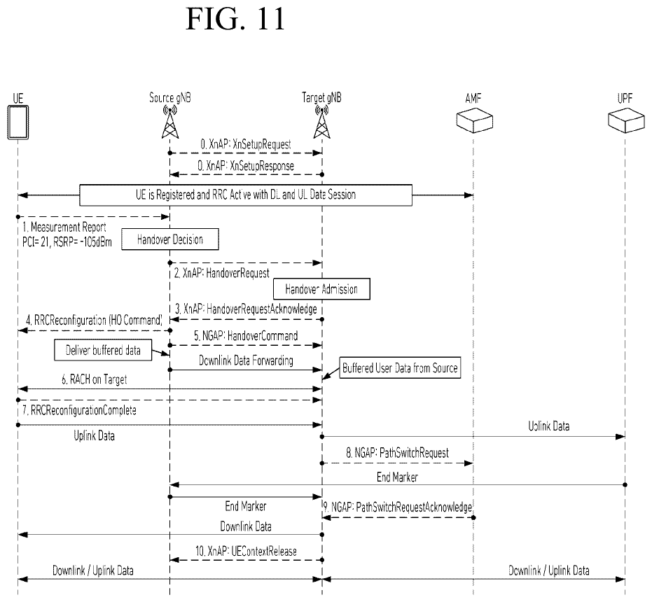

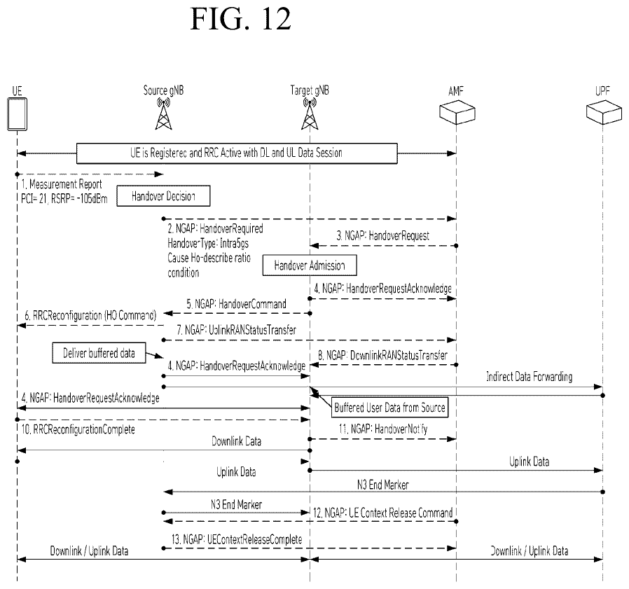

FIGS. 11 and 12 are diagrams illustrating specific embodiments of the present disclosure in a 5G system.

Specifically, FIG. 11 is a detailed diagram illustrating the Xn interface-based handover procedure described above with reference to FIG. 3, and FIG. 12 is a detailed diagram illustrating the AMF-initiated handover procedure described above with reference to FIG. 4.

First, referring to FIG. 11, in step 0, a source gNB and a target gNB establish an Xn interface, and a specific UE is registered even with an AMF of a CN through the source gNB.

In this state, the source gNB may periodically receive a measurement report from the UE (step 1), and based on this, make a handover decision. When the source gNB makes a handover decision, the source gNB may transmit a handover request message to the target gNB (step 2).

As described above, it is preferable that the handover request message includes information about bearers duplexed/multiplexed for one service flow. Based on this, the target gNB may process the handover request and then transmit a handover request Ack message through the Xn interface (step 3).

Upon receipt of the handover request Ack message from the target gNB, the source gNB may transmit an RRC reconfiguration message to the UE based on this, and the RRC reconfiguration message may correspond to a HO command (step 4). Based on this HO command, the UE may perform HO for entire duplexed/multiplexed DRBs at once, or only for a specific DRB first among them, which will be described in detail below.

After the HO command is transmitted, the source gNB may exchange SN status information with the target gNB, and accordingly, data may be exchanged between the gNBs through the Xn interface (step 5).

Thereafter, the UE may perform a random access procedure (RAP) with the target gNB (step 6). When the RAP is successful, the target gNB may transmit an RRC reconfiguration complete message to the UE (step 7), and accordingly, a radio access network (RAN) HO procedure may be considered complete.

However, to complete a HO procedure of a CN end, the target gNB may additionally transmit a path switch request message to an AMF and receive an Ack message for it (steps 8 and 9), and after this path switching is completed, the target gNB may instruct the source gNB to release a context of the corresponding UE (step 10).

Referring to FIG. 12, unlike FIG. 11, FIG. 12 illustrates a procedure in which handover is performed under the initiative of the CN, specifically the AMF, rather than the source gNB directly transmits a handover request message to the target gNB.

First, a specific UE is registered with the AMF of the CN through the source gNB.

In this state, the source gNB may periodically receive a measurement report from the UE (step 1), and based on this, decide on handover. When the source gNB decides on handover, the source gNB may notify the AMF that handover is required (step 2), and based on this, the AMF may transmit a handover request message to the target gNB (step 3).

As described above, it is preferable that the handover request message includes information about bearers that are duplexed/multiplexed for one service flow. Based on this, the target gNB may process the handover request and then transmit a handover request Ack message to the AMF (step 4).

In addition, the target gNB may transmit a handover command to the source gNB (step 5). Upon receipt of the handover command from the target gNB, the source gNB may transmit an RRC reconfiguration message to the UE based on this, and the RRC reconfiguration message may correspond to a HO command (step 6). Based on this HO command, the UE may perform HO at once for entire duplexed/multiplexed DRBs, or only for a specific DRB first among them, which will be described in detail below.

After the HO command is transmitted, the source gNB may transmit uplink RAN state information to the AMF (step 7), and based on this, the AMF may transmit downlink RAN state information to the target gNB (step 8). Accordingly, data exchange may be performed, and unlike the procedure of FIG. 10, the difference may be that indirect data exchange through the AMF/UPF occurs instead of direct exchange through the Xn interface.

Thereafter, the UE may perform a RAP with the target gNB (step 9). When the RAP is successful, the target gNB may transmit an RRC reconfiguration complete message to the UE (step 10), and accordingly, the RAN HO procedure may be considered complete.

However, to complete the HO procedure at the CN end, the target gNB may additionally notify the AMF of the handover completion, and accordingly, uplink/downlink data exchange may occur between the UE and the target gNB.

After the handover is complete, the AMF may instruct the source gNB to release a UE context, and accordingly, the source gNB may release the UE context and notify the AMF of the UE context release (steps 12 and 13).

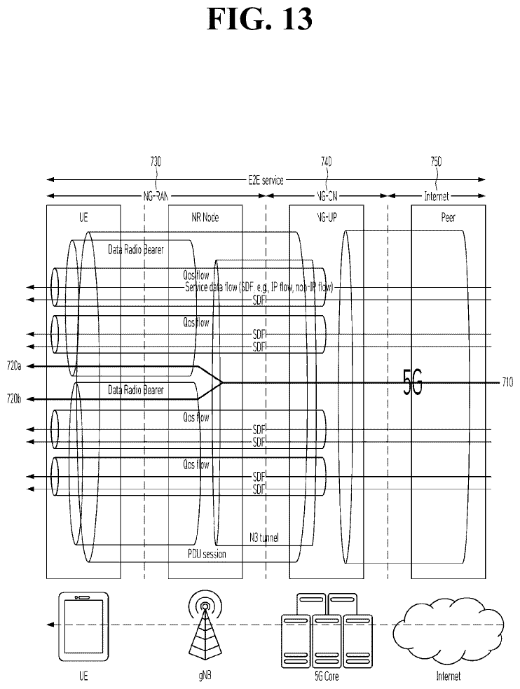

FIG. 13 is a diagram illustrating a structure for duplexing/multiplexing DRBs for an important communication service according to an embodiment of the present disclosure.

In FIG. 13, one arrow represents a service data flow (SDF), which may include an IP flow and a non-IP flow. Specifically, one SDF may be divided into an Internet link (750), a CN link 740, and a radio link 730.

From the perspective of flows, a network may be viewed as a concept including a gNB and a CN. In addition, an SDF that passes through a UE, the gNB, and the CN may be referred to as an end-to-end (E2E) QoS control flow.

As illustrated in FIG. 13, in duplexing or multiplexing of DRBs, an embodiment of the present disclosure focuses on the radio link 730 between the UE and the gNB rather than the CN link 740, and proposes to duplex/multiplex the DRBs in the radio link 730. This is because the CN link 740 is more stable than communication in the radio link 730, the duplexing/multiplexing of DRBs is focused in the radio link 740 without being performing in the CN link 740.

In the example of FIG. 13, although an SDF for C2 communication is configured as one link 710 in the Internet link 750 and the CN link 740, it is mapped to a first DRB 720a and a second DRB 720b in the radio link 730. That is, a single bearer (or single flow or single session) corresponding to the two or more bearers 720a and 720b may be configured in a link between the gNB and the CN on the link.

However, in another embodiment of the present disclosure, in a specific situation where reliability is threatened (e.g., a malicious user is detected) in the link between the gNB and the CN, two or more bearers (links) (or flows or sessions) may be configured in the same manner as the two or more DRBs 720a and 720b of the radio link.

As described above, bearer duplexing/multiplexing may be limited to the radio link in an embodiment of the present disclosure. In this case, when the target network device performs a RAP with the UE and then receives an RRC reconfiguration complete message from the UE, the handover of the UE may be considered successful. That is, since the handover on the radio link is completed after steps 7 and 10 of the handover procedures in FIGS. 11 and 12 are completed, respectively, this time point may be determined as a time point when the handover with bearer duplexing/multiplexing applied is completed.

In another embodiment of the present disclosure, the bearers may be duplexed/multiplexed on up to the CN link. In this case, when the target network device or the AMF instructs the source network device to release the context for the UE, the handover of the UE may be processed as successful. That is, since the handover on the CN link is completed after steps 10 and 13 of the handover procedures in FIGS. 11 and 12 are completed, respectively, this time point may be determined as a time point when the handover with bearer duplexing/multiplexing applied is completed.

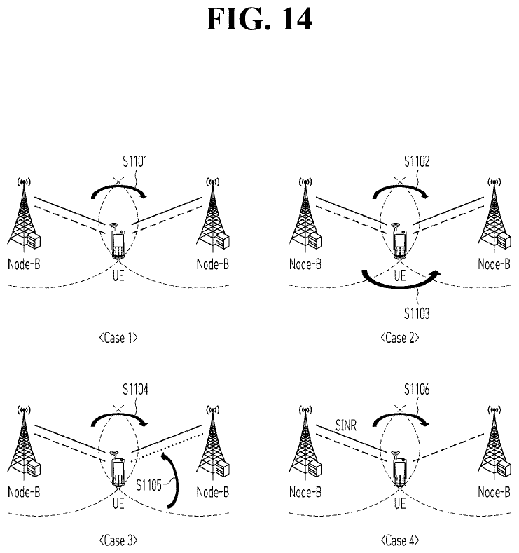

FIG. 14 is a diagram illustrating various handover scenarios according to embodiments of the present disclosure.

First, Case 1 in FIG. 14 is a conceptual diagram illustrating simultaneous handover of two DRBs in a situation where the two DRBs are used (S1101). In addition, Case 2 in FIG. 14 is a conceptual diagram illustrating a situation where two DRBs are divided into a primary DRB and a secondary DRB, and handover is first applied to a primary DRB (S1102) and then to the secondary DRB (S1103).

Case 3 is a conceptual diagram illustrating a situation where handover is first applied to the primary DRB (S1104), like Case 2, and then, instead of applying handover to the secondary DRB, the secondary DRB is added at a target node (S1105). In addition, Case 4 is a conceptual diagram illustrating a situation where handover is first applied to a DRB with a weak (or strong) signal strength measurement from the perspective of a source node (S1106), rather than a selection is made between the two DRBs based on the primary/secondary DRB distinction. The source node may determine the need of handover for the UE based on a measurement report received from the UE and transmit it to the target node in the form of a handover request message, and the target node may determine a bearer to which handover will be applied preferentially according to the reception of the handover request message from the source node. For the remaining DRB(s) in Case 4, subsequent handover may be applied as in Case 2, or DRB addition may be applied at the target node as in Case 3.

The description of FIG. 14 has been provided with the appreciation that two DRBs are applied to one important communication service flow, for convenience. However, the same concept may be applied, even when three or more DRBs are applied to one important communication service flow.

Further, among the four cases in FIG. 14, Case 1 is a case where handover is simultaneously applied to duplexed/multiplexed bearers, and Cases 2 to 4 may be generalized and conceptualized as a case where handover is first applied to any one of duplexed/multiplexed bearers.

In a preferred embodiment of the present disclosure, to provide a stable handover service for an important communication service, when handover is first applied to any one of duplexed/multiplexed bearers as in Cases 2 to 4, a handover method is proposed in which an additional connection with a target node is first established while a connection to the source node is maintained, and then the connection to the source node is released after the handover is completed. This may be conceptually similar to DAPS handover to be described later. However, since the conventional DAPS handover is not a technology applied to handover in a state where bearers are duplexed/multiplexed for one service flow, a specific method for applying the concept of DAPS handover in such a situation will be described.

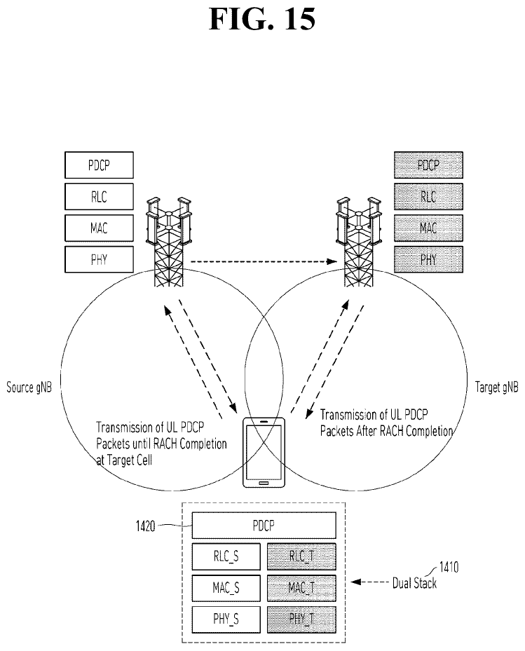

FIG. 15 is a diagram illustrating the concept of DAPS handover to be applied in an embodiment of the present disclosure.

Generally, a handover procedure performed from a source gNB to a target gNB may include a series of operations in which a UE performs uplink/downlink data exchange through the target gNB, after the UE successfully completes a RAP with the target gNB according to a handover command from the source gNB. Accordingly, there is a problem that uplink/downlink data exchange may not be performed during a time period until the UE successfully performs the RAP with the target gNB, and in the case of DAPS handover, a concept of performing handover while maintaining connections with both the source and target gNBs for a bearer to which the DAPS handover is applied (hereinafter, referred to as ‘DAPS bearer’) is proposed.

Specifically, when DAPS handover is applied, the UE may receive downlink PDCP packets from both the source and target gNBs. In addition, the UE may transmit an uplink PDCP packet through a source cell until it successfully performs the RAP with the target cell, and through the target cell after it successfully performs the RAP with the target cell.

Since the UE is doubly connected to the source and targets cell for the corresponding DAPS bearer during the DAPS handover, it may perform uplink/downlink data communication by configuring a dual stack 1410, as illustrated in FIG. 15. In the dual stack 1410, the PDCP 1420 has a structure commonly applied to both the source cell and the target cell, which may serve to prevent duplication/loss of PDCP packets.

The DAPS handover procedure described above with reference to FIG. 15 may be seen as performing a handover procedure by performing dual connectivity to the source cell and the target cells for one bearer during the handover process. In contrast, in an embodiment of the present disclosure, in a state where a communication service flow is received from the source cell through two or more bearers, a DAPS handover procedure is performed for any one (hereinafter, referred to as ‘first bearer’) of these two or more bearers, as described above.

That is, for the first bearer among the two or more bearers, it is proposed to establish an additional connection with the target cell while maintaining the connection to the source cell (or serving cell or source gNB), so that uplink/downlink data transmission is possible through the source cell (or serving cell or source base station) even before the RAP with the target cell is successful. However, unlike the existing DAPS handover, the handover request message/handover request Ack message additionally includes information about duplexed/multiplexed bearers, handover is configured to be completed after processing (e.g., additional handover, DRB addition, and so on as in Cases 2 to 4 of FIG. 14) is performed on bearers not designated as DAPS bearers with the target cell, that is, after the duplexing/multiplexing configuration of bearers for the corresponding service flow is completed with the target cell, and it is preferable to release the connection from the source cell after the handover completion.

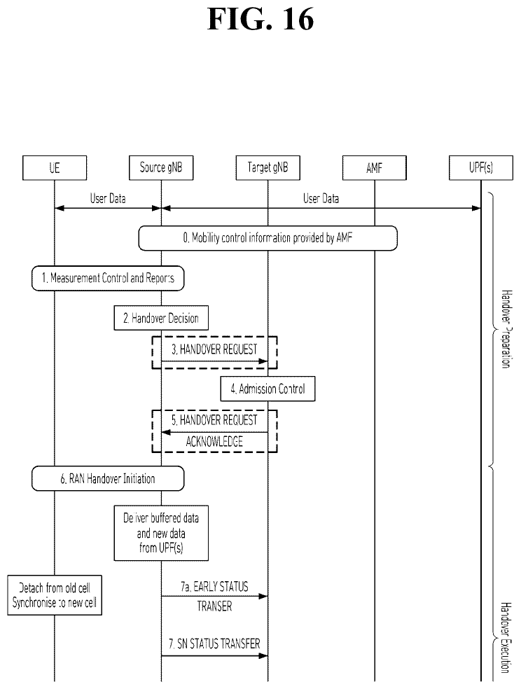

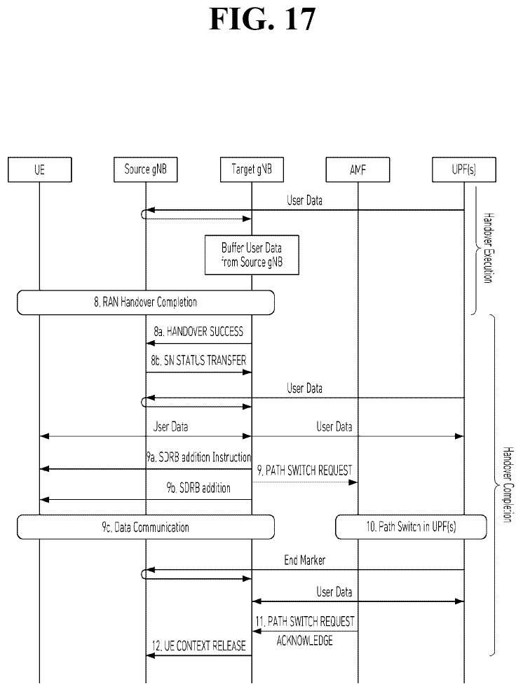

FIGS. 16 and 17 are diagrams illustrating a method for applying DAPS handover according to an embodiment of the present disclosure.

Although the examples of FIGS. 16 and 17 are described mainly in the context of the handover through the Xn interface described above with reference to FIG. 11, they may also be applied in a similar manner to AMF-initiated handover as illustrated in FIG. 12.

First, user data of a specific UE may be shared with up to the CN end through the source gNB, and the AMF may provide mobility control information for the UE (step 0). In this state, the source gNB may make a handover decision based on a measurement report received from the UE (step 1) (step 2), and accordingly, transmit a handover request message to the target gNB (step 3).

As described above, it is preferable that the handover request message includes information about bearers that are duplexed/multiplexed for one service flow. Based on this, the target gNB may perform processing on the handover request (step 4) and then transmit a handover request Ack message to the source gNB through an Xn interface (step 5).

In the example of FIG. 16, the handover request message and/or the handover request Ack message described above may additionally include information that designates any one (the first bearer) of these bearers as a DAPS bearer in addition to the information about duplexed/multiplexed bearers. Based on this, upon receipt of the handover request Ack message from the target gNB, the source gNB may transmit an RRC reconfiguration message (HO command) to the UE, and the RRC reconfiguration message may include information that sets the first bearer as a DAPS bearer.

Based on the HO command, the UE may perform DAPS handover for the first bearer.

After the HO command is transmitted, the source gNB may transmit early status information to the target gNB, and subsequently exchange SN status information (step 7a and step 7b) to support uplink/downlink data communication during DAPS handover. Herein, the PDCP of the UE may be commonly shared between the source node and the target node, so that data duplication/loss may be managed.

The UE may successfully perform the RAP with the target gNB, thereby completing RAN handover (step 8). That is, the completion of the RAN handover for the first bearer may be determined on the condition that the RAP is successful. The success of the RAP may be based on the premise that the target gNB transmits an RRC reconfiguration complete message to the UE after the RAP success of the UE.

Thereafter, the target gNB may notify the source gNB of the handover success (step 8a) and receive SN status information (step 8b), so that data exchange may be performed mainly with the target gNB.

The present embodiment proposes to additionally perform a procedure for completing duplexing/multiplexing for a corresponding bearer in a target cell after success of such RAN DAPS handover.

In the example of FIG. 17, the target gNB transmits a command to add a secondary DRB to the UE (step 9a), and accordingly, the UE adds the secondary DRB with the target gNB (step 9b), by way of example. However, a method for duplexing/multiplexing bearers for a corresponding service flow in a target gNB may be performed in various ways as in Cases 2 to 4 of FIG. 14.

Accordingly, the UE may perform data communication with the target gNB through duplexed/multiplexed bearers for one service flow.

As described above, according to an embodiment of the present disclosure, it is proposed that the procedure for adding the secondary DRB (steps 9a and 9b) be performed after the SN status information exchange in steps 8a and 8b. That is, it is preferable to add the secondary DRB and thus duplex/multiplex DRBs for a corresponding service flow even within the target cell, regardless of the path switch request performed with the CN end (AMF) by the target gNB (steps 9 to 11) after the SN status information exchange. This is even more so when bearer duplexing/multiplexing for one service flow is limited to the RAN link.

When bearer duplexing/multiplexing is applied not only to the RAN link but also to the CN link, it is preferable that the path switch request message of the target gNB (step 9) requests path switching in consideration of information about the added DRB.

After completing the duplexing/multiplexing for the corresponding service flow within the target cell in this way, the target gNB may instruct the source gNB to release a UE context (step 12).

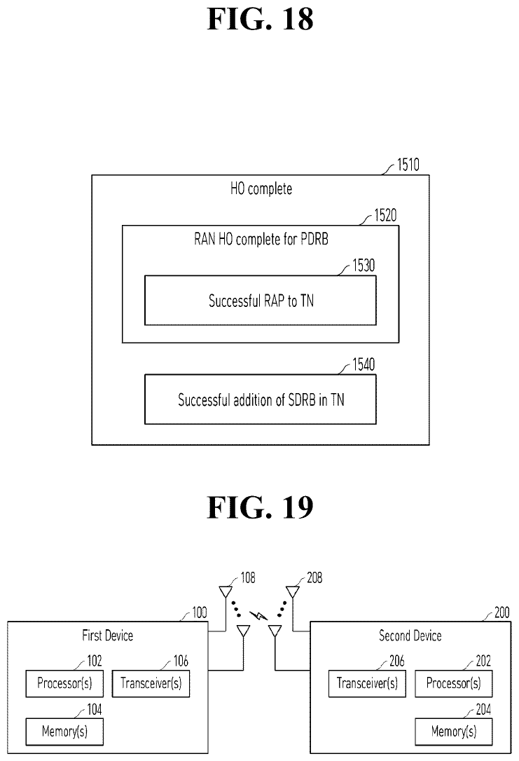

FIG. 18 is a conceptual diagram illustrating handover according to an embodiment of the present disclosure in comparison with general DAPS handover.

As described above, the general DAPS handover is applied to a specific bearer (DAPS bearer), and the completion of the RAN handover (1520) for the corresponding bearer may be determined based on whether the RAP with the target node is successful (1530). That is, in the case of the general DAPS handover, the completion of the RAN handover for the first bearer specified as a DAPS bearer in the handover request message/handover request Ack message may be determined, when the RAP is successful at the target node.

However, for handover according to the present embodiment, a criterion for the completion of the handover may be also establishing a stable service at the target node by completing duplexing/multiplexing for the corresponding service flow at the target node, and therefore, according to the present embodiment, whether the handover is completed (1510) may be determined based not only on the successful RAP with the target node (1530) but also on the completion of handover/addition (1540) of the remaining bearers (second bearer or secondary DRB) for duplexing/multiplexing other than the first bearer as a condition for the handover completion (1510).

After the handover completion (1510) is determined in this way, the target node may instruct the source node to release a UE context, and the DAPS handover according to the present embodiment may be completed.

FIG. 19 illustrates wireless devices applicable to the present technology.

Referring to FIG. 19, a first wireless device 100 and a second wireless device 200 may transmit and receive radio signals through a variety of RATs (e.g., LTE and NR). Herein, the first wireless device 100 and the second wireless device 200 may correspond to the UE and the network of FIG. 2, respectively. Specifically, the first wireless device 100 and the second wireless device 200 may be applied to various device located at both ends of a communication link of the UAS illustrated in FIG. 1.

The first wireless device 100 may include at least one processor 102 and at least one memory 104 and further include at least one transceiver 106 and/or at least one antenna 108. The processor 102 may be configured to control the memory 104 and/or the transceiver 106 and implement the description, functions, procedures, proposals, methods, and/or operational flowcharts disclosed in the present disclosure. For example, the processor 102 may process information within the memory 104 to generate first information/signal and then transmit a radio signal including the first information/signal through the transceiver 106. Further, the processor 102 may receive a radio signal including second information/signal through the transceiver 106 and then store information obtained by processing the second information/signal in the memory 104. The memory 104 may be connected to the processor 102 and store various pieces of information related to operations of the processor 102. For example, the memory 104 may store software code including commands for performing some or all of processes controlled by the processor 102 or for performing the description, functions, procedures, proposals, methods, and/or operational flowcharts disclosed in the present disclosure. The processor 102 and the memory 104 may be a part of a communication modem/circuit/chip designed to implement RATs (e.g., LTE E-UTRA or 5G NR). The transceiver 106 may be connected to the processor 102 and transmit and/or receive a radio signal through the at least one antenna 108. The transceiver 106 may include a transmitter and/or a receiver. The transceiver 106 may be interchangeably used with a radio frequency (RF) unit. In the present disclosure, the wireless device may refer to a communication modem/circuit/chip.

The second wireless device 200 may include at least one processor 202 and at least one memory 204 and further include at least one transceiver 206 and/or at least one antenna 208. The processor 202 may be configured to control the memory 204 and/or the transceiver 206 and implement the description, functions, procedures, proposals, methods, and/or operational flowcharts disclosed in the present disclosure. For example, the processor 202 may process information within the memory 104 to generate third information/signal and then transmit a radio signal including the third information/signal through the transceiver 206. Further, the processor 202 may receive a radio signal including fourth information/signal through the transceiver 206 and then store information obtained by processing the fourth information/signal in the memory 204. The memory 204 may be connected to the processor 202 and store various pieces of information related to operations of the processor 202. For example, the memory 204 may store software code including commands for performing some or all of processes controlled by the processor 202 or for performing the description, functions, procedures, proposals, methods, and/or operational flowcharts disclosed in the present disclosure. The processor 202 and the memory 204 may be a part of a communication modem/circuit/chip designed to implement RATs (e.g., LTE E-UTRA or 5G NR). The transceiver 206 may be connected to the processor 202 and transmit and/or receive a radio signal through the at least one antenna 208. The transceiver 206 may include a transmitter and/or a receiver. The transceiver 206 may be interchangeably used with an RF unit. In the present disclosure, the wireless device may refer to a communication modem/circuit/chip.

Hereinafter, hardware elements of the wireless devices 100 and 200 will be described more specifically. One or more protocol layers may be implemented by, but are not limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more protocol data units (PDUs) and/or one or more service data units (SDUs) according to the description, functions, procedures, proposals, methods, and/or operational flowcharts disclosed in the present disclosure. The one or more processors 102 and 202 may generate messages, control information, data, or information according to the description, functions, procedures, proposals, methods, and/or operational flowcharts disclosed in the present disclosure. The one or more processors 102 and 202 may generate signals (e.g., baseband signals) including PDUs, SDUs, messages, control information, data, or information according to the description, functions, procedures, proposals, methods, and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and obtain the PDUs, SDUs, messages, control information, data, or information according to the description, functions, procedures, proposals, methods, and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The description, functions, procedures, proposals, methods, and/or operational flowcharts disclosed in the present disclosure may be implemented using firmware or software and the firmware or software may be configured to include the modules, procedures, or functions. Firmware or software configured to perform the description, functions, procedures, proposals, methods, and/or operational flowcharts disclosed in the present disclosure may be included in the one or more processors 102 and 202 or stored in the one or more memories 104 and 204 so as to be driven by the one or more processors 102 and 202. The description, functions, procedures, proposals, methods, and/or operational flowcharts disclosed in the present disclosure may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured as read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located inside and/or outside of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of the present disclosure, to one or more other devices. The one or more transceivers 106 and 206 may receive user data, control information, and/or radio signals/channels, mentioned in the description, functions, procedures, proposals, methods, and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may control the one or more transceivers 106 and 206 to transmit user data, control information, or radio signals to one or more other devices. The one or more processors 102 and 202 may control the one or more transceivers 106 and 206 to receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the description, functions, procedures, proposals, methods, and/or operational flowcharts disclosed in the present disclosure, through the one or more antennas 108 and 208. In the present disclosure, the one or more antennas may be a plurality of physical antennas or a plurality of logical antennas (e.g., antenna ports). The one or more transceivers 106 and 206 may convert received radio signals/channels from RF band signals into baseband signals in order to process received user data, control information, and radio signals/channels, using the one or more processors 102 and 202. The one or more transceivers 106 and 206 may convert the user data, control information, and radio signals/channels, processed using the one or more processors 102 and 202 from the base band signals into the RF band signals. To this end, the one or more transceivers 106 and 206 may include (analog) oscillators and/or filters.

The detailed description of the preferred embodiments of the present disclosure disclosed above has been provided to enable those skilled in the art to implement and practice the present disclosure. Although the above description has been given with reference to preferred embodiments of the present disclosure, it will be understood by those skilled in the art that various modifications and changes may be made to the present disclosure without departing from the scope of the present disclosure. For example, those skilled in the art may use configurations described in the above-described embodiments in combination.

Accordingly, the present disclosure is not intended to be limited to the embodiments shown herein, but is intended to have the broadest scope consistent with the principles and novel features disclosed herein.

### Industrial Applicability

The method and apparatus for stably providing an important communication service according to the embodiments of the present disclosure as described above may be used in a communication system that supports an important service such as a C2 communication service of a UAS according to various communication protocols as well as the 3GPP.

1. A method for performing handover by a user equipment (UE) in a mobile communication system, the method comprising:
receiving one communication service flow from a source network device through two or more bearers;
establishing an additional connection with a target network device while maintaining a connection to the source network device, for a first bearer among the two or more bearers; and
after completing a handover procedure with the target network device, disconnecting the two or more bearers from the source network device.

2. The method of claim 1, further comprising:
receiving a first message indicating addition of at least one second bearer among the two or more bearers from the target network device, after completing a radio link handover procedure for the first bearer with the target network device; and
additionally connecting the at least one second bearer to the target network device based on the first message.

3. The method of claim 2, wherein the completion of the handover procedure is determined based on the at least one second bearer being additionally connected to the target network device.

4. The method of claim 2, wherein the completion of the radio link handover procedure for the first bearer is determined based on success of a random access procedure with the target network device.

5. The method of claim 1, wherein after the completion of a radio link handover procedure for the first bearer, the source network device receives the first message while performing sequence number status transfer for data exchange between the target network device and the UE after the completion of the handover procedure.

6. The method of claim 5, wherein each of the source network device and the target network device corresponds to a base station,
wherein the mobile communication system includes the base station and a core network (CN), and
wherein the two or more bearers are established on a radio link between the UE and the base station.

7. The method of claim 6, wherein the first message is received regardless of a path switching procedure between the target network device and the CN after the sequence number status transfer.

8. The method of claim 5, wherein each of the source network device and the target network device corresponds to a base station,
wherein the mobile communication system includes the base station and a CN, and
wherein the two or more bearers are established on a radio link between the UE and the base station, and two or more service flows having the same quality of service (QoS) flow identifier (QFI) mapped to each of the two or more bearers are created on a network link between the base station and the CN.

9. The method of claim 8, wherein a path switching procedure between the target network and the CN is performed by reflecting information of the first message, after the sequence number status transfer.

10. The method of claim 1, wherein the first bearer is configured as a dual active protocol stack (DAPS) bearer.

11. The method of claim 10, wherein the establishment of the additional connection with the target network device is performed based on receiving a handover command from the source network device, and
wherein the handover command includes a DAPS handover command specifying the first bearer as a DAPS bearer.

12. The method of claim 11, wherein the handover command is received based on a handover request acknowledgement (Ack) message received by the source network device from the target network device, and
wherein the handover request Ack message includes information about the two or more bearers for the UE.

13. The method of claim 1, wherein the two or more bearers correspond to two or more data radio bearers (DRBs), respectively,
wherein the two or more DRBs include a primary DRB and at least one secondary DRB, and
wherein the first bearer corresponds to the primary DRB.

14. The method of claim 1, wherein the mobile communication system includes an uncrewed aerial system (UAS), and
wherein the one communication service flow serviced through the two or more bearers includes a command and control (C2) communication service flow of the UAS.

15. The method of claim 14, wherein the mobile communication system includes the UAS and a mobile communication service provider system, and
wherein the source network device and the target network device link the mobile communication service provider system to the UAS.

16. The method of claim 14, wherein the UE includes an uncrewed aerial vehicle (UAV).

17. A method for supporting handover of a user equipment (UE) by a target network device, the method comprising:
receiving a handover request message for the UE by the target network device; and
transmitting a handover request acknowledgement (Ack) message in response to the handover request message by the target network device,
wherein at least one of the handover request message or the handover request Ack message includes information configuring a first bearer as a DAPS bearer among bearers configured for the UE to receive one communication service flow through two or more bearers from a source network device.

18. The method of claim 17, wherein the handover request message is received from the source network device, and
wherein the target network device transmits the handover request Ack message to the source network device.

19. The method of claim 17, wherein the handover request message is received from an access and mobility management function (AMF), and
wherein the target network device transmits the handover request Ack message to the AMF.

20. The method of claim 17, wherein after completion of a radio link handover procedure for the first bearer with the UE, a first message indicating addition of a bearer corresponding to a second bearer among the two or more bearers is transmitted to the UE.

21. The method of claim 20, wherein completion of a handover procedure for the DAPS bearer is determined based on the bearer corresponding to the second bearer being additionally connected between the UE and the target network device.

22. A user equipment (UE) for performing handover in a mobile communication system, comprising:
at least one processor; and
at least one computer memory operably connectable to the at least one processor and storing instructions that, when executed, cause the at least one processor to perform operations,
wherein the operations include:
receiving one communication service flow from a source network device through two or more bearers;
establishing an additional connection with a target network device while maintaining a connection to the source network device, for a first bearer among the two or more bearers; and
after completing a handover procedure with the target network device, disconnecting the two or more bearers from the source network device.

23. A target network device for supporting handover of a user equipment (UE), comprising:
at least one processor; and
at least one computer memory operably connectable to the at least one processor and storing instructions that, when executed, cause the at least one processor to perform operations,
wherein the operations include:
receiving a handover request message for the UE by the target network device; and
transmitting a handover request acknowledgement (Ack) message in response to the handover request message by the target network device, and
wherein at least one of the handover request message or the handover request Ack message includes information configuring a first bearer as a DAPS bearer among bearers configured for the UE to receive one communication service flow through two or more bearers from a source network device.
